(19) United States
(12) Patent Application Publication
(10) Pub. No.: US 2011/0270672 A1
(43) Pub. Date: Nov. 3, 2011

(54) Ad Relevance In Sponsored Search

(76) Inventors: Dustin Hillard, San Francisco, CA (US); Hema Raghavan, Arlington, MA (US); Eren Manavoglu, Menlo Park, CA (US); Chris Leggetter, Belmont, CA (US); Stefan Schroedl, San Francisco, CA (US)

(21) Appl. No.: 12/769,446

(22) Filed: Apr. 28, 2010

(51) Int. Cl. G06Q 30/00; G06F 15/18

(52) U.S. Cl. 705/14.42; 705/14.45; 706/12

(57) ABSTRACT

Techniques for improving advertisement relevance for sponsored search advertising. The method includes steps for processing a click history data structure containing at least a plurality of query-advertisement pairs, populating a first translation table containing a co-occurrence count field, populating a second translation table containing an expected clicks field, and calculating a click propensity score for an advertisement using the click history data structure, the first translation table (for determining overall click likelihood across all historical traffic), and using the second translation table (for removing biases present in the first translation table). Other method steps calculate a second click propensity score for a second advertisement, then ranking the first advertisement relative to the second advertisement for comparing a click propensity score to a threshold for filtering low quality ad candidates from a plurality of ad candidates, and then ranking advertisements for optimizing placement of ads on a sponsored search display page.

### FIELD OF THE INVENTION

The present invention is directed towards search advertising, and more particularly to improving advertisement relevance in sponsored search.

### BACKGROUND OF THE INVENTION

Large commercial search engines typically provide organic web results in response to user queries and then supplement those organic results with sponsored results that generate revenue based on a “cost-per-click” billing model. Sponsored results are selected from a database populated by advertisers that bid to have their ads shown on the search results page. A search engine typically decides which ads to show (and in what order) by optimizing revenue based on the probability that an ad will be clicked, combined with the cost of the ad. Beyond selecting and ranking potential ads, a search engine also must decide how many ads to show and how prominently (such as above the search results, or at the side) to show them. A search engine could likely increase short term revenue by increasing the number and prominence of sponsored results, but such an approach typically would reduce overall quality and eventually result in users switching to another search engine. Each search engine chooses how aggressively to advertise based on a balance of business goals that incorporate both revenue generation as well as estimated user impact. While adding a ‘perfect’ advertisement to a search results page may actually improve user experience, most search engine users find that, generally, the presence of sponsored links based on legacy relevance models somewhat degrades the search experience.

The legacy relevance models are able to make predictions based on simple text overlap features, but such legacy models fail to detect relevant ads if no syntactic overlap is present. Thus, an ad with the title “Find the best jogging shoes” could be very relevant to a user search query “running gear”, but legacy models have no syntactic correlation that running and jogging are highly related. Thus an improved relevance model is needed in order to improve the user search experience while improving revenue based on the aforementioned “cost-per-click” billing model. Moreover, legacy relevance models suffer from a presentation bias, as learned from correlations, namely that a learned model might yield high correlation scores due to immense traffic, even though the click rate was low.

Thus, for these and other reasons, there exists a need for improving advertisement relevance determination in sponsored search, and using the relevance determination for optimizating the selection and placement of advertisements presented to a user in a network-based sponsored search advertising environment.

### SUMMARY OF THE INVENTION

Machine learning techniques are employed to calculate a likelihood ratio, or click propensity, that provides a click propensity score that removes presentation bias from log-based machine learning translation models. The click propensity score normalizes historical events so as to scale by the probability of clicks that would be expected on average from the same history of events.

The method includes steps for processing a click history data structure containing at least a plurality of query-advertisement pairs, populating a first translation table containing a co-occurrence count field (e.g. a click co-occurrence count), populating a second translation table containing an expected clicks field, and calculating a click propensity score for an advertisement using the click history data structure, the first translation table (for determining overall click likelihood across all historical traffic), and using the second translation table (for removing biases present in the first translation table). Other method steps calculate a second click propensity score for a second advertisement, then ranking the first advertisement relative to the second advertisement for comparing a click propensity score to a threshold for filtering low quality ad candidates from a plurality of ad candidates, and then ranking selected advertisements for determining the placement of ads on a sponsored search display page.

### BRIEF DESCRIPTION OF THE DRAWINGS

The novel features of the invention are set forth in the appended claims. However, for purpose of explanation, several embodiments of the invention are set forth in the following figures.

FIG. 1 depicts a sponsored search advertising network environment including modules for improving advertisement relevance determination in sponsored search, in which some embodiments operate.

FIG. 2 depicts a data flow within a search engine server for improving ad relevance in sponsored search, according to one embodiment.

FIG. 3 depicts a method within a search engine server for improving ad relevance in sponsored search, according to one embodiment.

FIG. 4 depicts a system within a search engine server for improving ad relevance in sponsored search, according to one embodiment.

FIG. 5 depicts a method within a system for sponsored search advertising including operations for improving advertisement relevance determination in sponsored search, according to one embodiment.

FIG. 6 depicts a block diagram of a system for sponsored search advertising including modules for improving advertisement relevance determination in sponsored search, according to one embodiment.

FIG. 7 is a diagrammatic representation of a network including nodes for client computer systems, nodes for server computer systems, and nodes for network infrastructure, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

Search engines typically implement “sponsored search” by displaying sponsored listings on the top (“north”) and the right hand side (“east”) of the web-search results in response to a user query. The revenue model for these listings is “cost-per-click” where the advertiser pays only if the advertisement is clicked. Such a sponsored search capability offers a more targeted and less expensive way of marketing for most advertisers as compared to media like TV and newspapers and has therefore gained momentum in the recent few years, becoming a multi-billion dollar industry. In sponsored search contexts, the advertiser “targets” a particular audience by selecting specific search query keyword markets and by bidding on such search query keywords. For example, an advertiser selling shoes may bid on user search queries such as “cheap shoes”, “running shoes” and so on. The need for an approach to improving advertisement relevance determination in sponsored search may be inferred from the foregoing. In commercial embodiments, the implementation of sponsored search capability may involve a network-based sponsored search advertising environment, possibly comprising any number of network components.

### Overview of Networked Systems for Sponsored Search Advertising

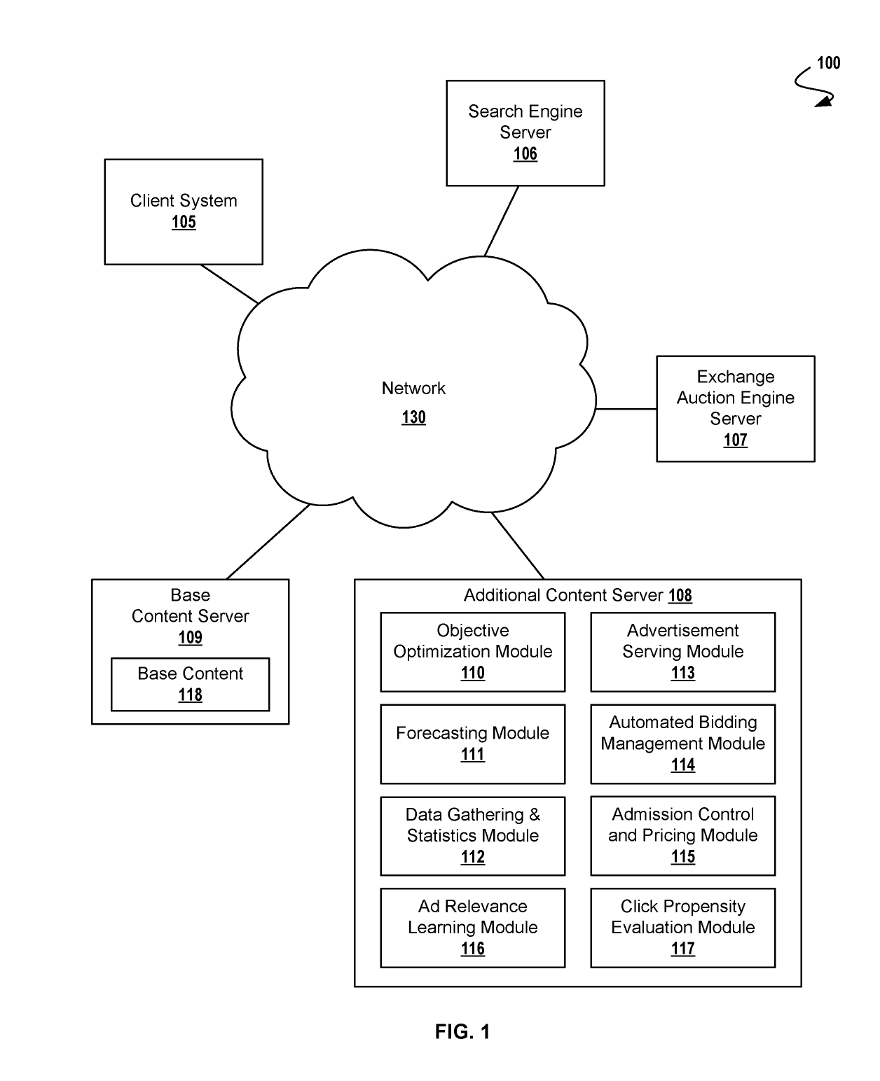

FIG. 1 depicts a sponsored search advertising network environment including modules for improving advertisement relevance determination in sponsored search. The sponsored search network environment implements a system for delivery of sponsored search advertising, in which advertising is selected using one or more techniques for improving advertisement relevance. In the context of sponsored search advertising, placement of advertisements within a search results page has become common. By way of a simplified description, an internet advertiser may select a particular set of keywords and may create an advertisement such that whenever any internet user, via a client system server 105 renders the web page from search, possibly using a search engine server 106, the advertisement is composited on the web page by one or more servers (e.g. a search engine server 106, a base content server 109, an additional content server 108, etc) for delivery to a client system server 105 over a network 130. Given this generalized delivery model, and using techniques disclosed herein, sophisticated online advertising might be practiced. Again referring to FIG. 1, an internet property (e.g. a publisher hosting the publisher's base content 118 on a base content server 109) might present content, possibly using an additional content server 108 in conjunction with a data gathering and statistics module 112, and such content might inspire a user to perform a search (e.g. content related to track and field sports might inspire a user to search based on a query, “running shoes”), and the user might then invoke a search, possibly using a search engine server 106. The operator of the search engine service might then elect to bid in a market via an exchange auction engine server 107 in order to win a prominent spot on the displayed search results page.

In some embodiments, the environment 100 might host a variety of modules to serve management and control operations (e.g. an objective optimization module 110, a forecasting module 111, a data gathering and statistics module 112, an advertisement serving module 113, an automated bidding management module 114, an admission control and pricing module 115, an ad relevance learning module 116, a click propensity evaluation module 117, etc) pertinent to serving advertisements to users. In particular, the modules, network links, algorithms, assignment techniques, serving policies, and data structures embodied within the environment 100 might be specialized so as to perform a particular function or group of functions reliably while observing capacity and performance requirements. For example, a search engine server 106, possibly in conjunction with an ad relevance learning module 116, and a click propensity evaluation module 117, might be employed to implement an approach for improving advertisement relevance determination in sponsored search.

Various concepts and terms used in search engine monetization (SEM) are used herein. For example, a search engine server 106 might implement a sponsored search advertising campaign using a search engine monetization module and a search engine optimization module.

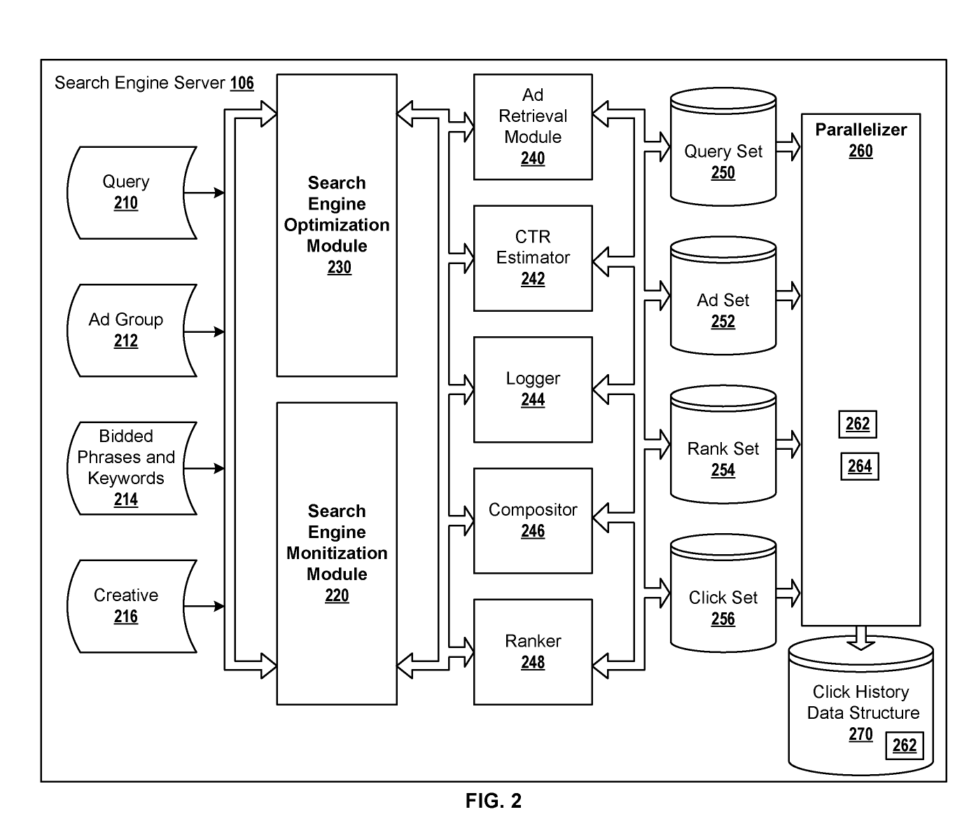

FIG. 2 depicts a data flow within a search engine server for improving ad relevance in sponsored search. Of course, the search engine server 106 is an exemplary embodiment, and some or all (or none) of the data flows or operations or characteristics mentioned in the discussion of FIG. 2 might be carried out or be present in any environment. As shown, a search engine server 106 might implement a sponsored search advertising campaign where elements of the campaign comprise an ad group 212 (or possibly many ad groups) and where each ad group in turn consists of a set of bidded phrases and keywords 214 that the advertiser seeks to bid on, e.g. “sports shoes”, “stilettos”, “canvas shoes”, etc. A creative 216 is associated with an ad group 212 and such a creative 216 might comprise a title, an ad description, and a display URL. In some embodiments, the title is 2-3 words in length and the description has about 10-15 words. In exemplary operation, the search engine server receives a query 210, and presents search results, including one or more advertisements from the ad group 212. The user then may browse the search results page, possibly clicking on an advertisement. Clicking on an ad leads the user to a landing page as may be specified by the advertiser. An advertiser can choose to use a standard technique or may choose to use an advanced match technique for processing the keywords in an ad group. For example, enabling only a standard match technique for the keyword “sports shoes” will result in the corresponding creative being shown only for that exact query. If the keyword is enabled for an advanced match technique, the search engine might show the same ad for the related queries “running shoes” or “track shoes.” A bid is associated with each keyword and a second price auction model determines how much the advertiser pays for the click.

In some embodiments, a search engine server 106 might implement a three-stage approach to the sponsored search problem by: (1) finding relevant ads for a query, (2) estimating click-through rate (CTR) for the retrieved ads and appropriately ranking those ads, and (3) selecting how to display the ads on the search page (e.g. how many ads to show in the north section, east section, etc). As shown, a search engine monetization module 220 and a search engine optimization module 230 might operate cooperatively to find relevant ads for a query using an ad retrieval module 240, from which selected ads might be evaluated using a CTR estimator 242. In turn, a ranker 248 might produce data items for a compositor 246 which compositor module constructs a search results page with one or more ads for presentation to the user issuing the query 210 that invoked the search.

As earlier described, a search engine optimization module might perform some calculations intended to maximize revenue while operating within some guidelines or constraints. In exemplary embodiments, a search engine optimization module might employ a logger 244 for capturing the correlations between a query and an ad, the rank (position on the search results page), and the occurrence of a click. Such a logger might merely store timestamped (or use some other identifying code) queries into a query set 250, ads into an ad set 252, ranks into a rank set 254, and/or clicks into a click set 256. Or, a logger might invoke or execute cooperatively with a parallelizer 260 to produce a click history data structure 270.

In some cases a parallelizer 260 might produce query-advertisement pairs 262 and click-ad pairs 264 and store said pairs into a dataset structured specifically for describing and modeling clicks for revenue optimization. In other exemplary embodiments, a parallelizer 260 might produce a click history data structure 270 structured specifically for predicting ad relevance in order to automatically identify (and filter) low relevance ads. Such an approach can be thought of as an information retrieval ranking task that aims at predicting advertisement relevance (rather than directly modeling the probability that a user will click on an advertisement). Given a good prediction of advertisement relevance, a search engine optimization module might serve to alter or optimize multiple aspects of the sponsored search system results with the goal of improving overall quality, revenue generation, and/or other metrics.

### Distinctions Between Information Retrieval (Web Search) and Sponsored Search Advertising

Finding ads that have high relevance to a query is an information retrieval problem and the nature of the queries makes the problem quite similar to a web search. Yet, there are some key differences between a web search and a sponsored search. One of the primary differences is that the collection of web documents is significantly larger than the advertiser database. In addition, sponsored search advertisements may relate to the query in a more broad sense than would be reasonable for web results. For example, an ad for “limo rentals” might be considered to be relevant to a search for “prom dress” from the perspective of an advertiser (and/or the advertiser's target); however, “prom dress” might not likely be a reasonable top organic web result against query “limo rentals”. Still, such an ad for “prom dress” might in fact be relevant to the user, and in fact might be relevant to users at large. Thus, at least for optimizing revenue, a search engine might seek to optimize revenue by knowing the probability P that a click would occur (a revenue event) based on the presentation of a particular advertisement.

### Impact of Advertisement Relevance to Sponsored Search Advertising Revenue

In one possible revenue model, after retrieving a set of ads {a₁ . . . aₙ} for a query q shown at ranks 1 . . . n on search results page, the expected revenue is given as:

$$R = {\sum }_{i}^{n} P ( click \vert q , {a}_{i} ) \times cos t ( {q}^{′} , {a}_{i} , i ) \qquad ( 1 )$$

where cost(q′,a,i) is the cost of a click for the ad aᵢ at position i for the bidded phrase q′. In the case of standard match q=q′, most search engines rank the ads as a function of the estimated CTR, P(click|q,aᵢ), and would then bid a corresponding amount in an attempt to maximize revenue. Therefore, accurately estimating the CTR for a query-advertisement pair is a very important task that has significant revenue implications. One simple approach is to use the observed historical CTR statistics for query-advertisement pairs that have been previously shown to users. However, the ad inventory is continuously changing with advertisers adding, replacing and editing ads. Likewise, many queries and ads have few or zero past occurrences in the logs. These factors make the CTR estimation of rare and new queries the subject of certain techniques disclosed herein.

When a set of ads has been retrieved and ranked, a search engine must then decide how many ads to show, and where to place the ads on the search results page. Many queries do not strongly correlate to commercial intent on the part of the user, so displaying ads on the top of a page for a query like “formula for mutual information” may hurt user experience and occupy real estate on the search results page in a spot where more relevant web search results might otherwise be positioned. Therefore, in some embodiments of sponsored search, it is preferred not to show any ads when the estimate of CTR and/or relevance of the ad is low. Determining how many candidate documents to retrieve and display is less crucial in web search because the generally accepted user model is one where users read the page in sequence and exit the search session when their information need is satisfied. Contrasting to web search, in sponsored search the search engine must decide how many ads to place in the north page section above the web results. Also, the search engine must decide the total number of ads. Placing irrelevant ads above the search results damages user experience and should be avoided as much as possible. Likewise, placing too many ads on a page also degrades overall user experience, particularly if low relevance ads are displayed.

### A Machine Learning Approach for Predicting Sponsored Search Ad Relevance

Next described is a machine learning approach for predicting sponsored search ad relevance. The baseline model incorporates basic features of text overlap and then the model is extended to learn from past user clicks on advertisements. The approach uses translation models to learn user click propensity, even from sparse click logs.

The predicted click propensity score might be used to improve the quality of the search page in three areas: filtering low quality ads, more accurate ranking for ads, and optimized page placement of ads to reduce prominent placement of low relevance ads.

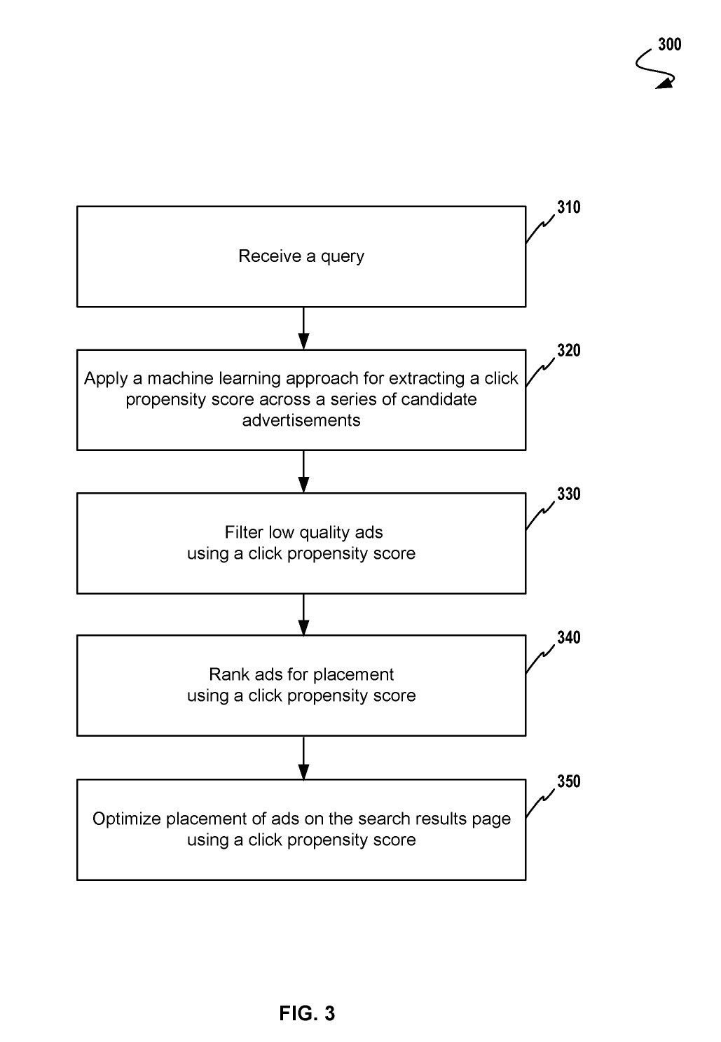

FIG. 3 depicts a method 300 within a search engine server for improving ad relevance in sponsored search. Of course, the method 300 is an exemplary embodiment, and some or all (or none) of the operations or characteristics mentioned in the discussion of FIG. 3 might be carried out or present in any environment. The method 300 commences upon receipt of a query (see operation 310). The query, in combination with any one or more of the aforementioned data sets or data structures (e.g. a click history data structure 270), might be used in implementing a machine learning approach for extracting a click propensity score across a series of candidate advertisements, then using the click propensity score for filtering low quality ads for more accurate ranking for ads, and then for optimized page placement of ads to reduce prominent placement of low relevance ads. As shown, the method steps serve to apply a machine learning approach for extracting a click propensity score across a series of candidate advertisements (see operation 320), filter low quality ads using a click propensity score (see operation 330), rank ads for placement using a click propensity score (see operation 340), and optimize placement of ads on the search results page using a click propensity score (see operation 350).

Relevance models based solely on simple text overlap features herein are able to predict relevance in some cases, but may fail to detect relevant ads where no syntactic overlap is present (even though the semantics are strongly overlapping). For example, an ad with the title “Find the best jogging shoes” could be very relevant to a user search “running gear”, but the simple text overlap feature model has no knowledge that running and jogging are semantically related.

### A Machine Learning Approach Using Translation Tables

One possible machine learning technique used for improving ad relevance in sponsored search involves use of one or more translation tables. For example, a translation dictionary may relate the term of a query “digital camera” to an advertisement for an “a40”, which may be a popular model of a digital camera. Such a relation can be learned on the basis of co-occurrence. Continuing with the example, using a click history data structure 270 that includes at least correlated records from a query set 250 and an ad set 252, it might be determined that there is a statistically high co-occurrence count for correlated queries (e.g. contemporaneously timestamped, correlated by user, correlated by user characteristics, etc) containing the words “digital camera” and for advertisements containing the word “a40”. Thus, using purely statistical methods, a translation table is learned from a click history data structure 270, Moreover, such a relation may be represented as a probability that a user will select products, pages, and/or articles including “a40” in response to the “digital camera” query. In some embodiments, building a database of click-through information (e.g. a click history data structure 270) may be a periodic process (e.g. a daily process) in order to capture changing conditions on the Internet. For example, information pertaining to new commercial products may regularly be added to the Internet so that search results of a query may correspondingly change and expand over time. Accordingly, a translation dictionary that incorporates click-through information may also change over time. Following the above example, an translation table (aka a translation dictionary) populated at some point in time may relate the term of a query “digital camera” to “a40”. At a later time, however, a model “a80” may become a more popular digital camera model compared to an “a40”. In such a case, a translation dictionary, possibly extracted from an updated version of a click history data structure 270 (which represents multiple users' recent activities on the Internet), may now relate the term of the query “digital camera” to “a80” with a higher selection probability than for “a40”. Also in such a case, and again using a click history data structure 270, the occurrence of “a40” may now be more closely related to a query such as “used digital camera” since an older model, compared to the new “a80”, may be widely available as a used product.

### A Machine Learning Approach Using Click History as a Relevance Feature

Historical click rates for a query-advertisement pair can provide a strong indication of relevance and can be used as features in the relevance model. It has been observed that user click rates often correspond well with editorial ratings when a sufficient number of clicks and impressions have been observed. The relationship is, however, not deterministic across all datasets, so the relevance model may be configured to learn from observed click rates. When there is no click history for a specific query-advertisement pair, or when the click history for a specific query-advertisement pair is not statistically reliable, it may be reasonable to ‘back off’ to levels of lower granularity, learning from broader terms or phrases, or using techniques or datasets that aggregate history across multiple (or all) ads in an adgroup, campaign, or across an entire account. In some cases, ads that are new to the system or that occur for infrequently observed terms may not have a statistically reliable click history.

### Click Propensity in Query/Ad Translation

While the click features discussed above are helpful in determining click propensity for ads with a statistically reliable click history, click information can be used to learn relationships that are not tied to a particular ad. In some exemplary embodiments, the query is viewed as a translation of a document D (i.e. using the terminology of information retrieval) where the relevance of a document D (in this case, the advertisement) to a query can be modeled with Bayes' rule as:

p(D|Q)=p(Q|D)p(D)/p(Q) (2)

where p(Q) can be ignored because it is constant for each particular query. The p(Q|D) term can be considered a statistical translation problem and decomposed using a standard translation model in the form:

$$p ( Q \vert D ) = {\prod }_{j = 0}^{m} {\sum }_{i = 0}^{n} trans ( {q}_{j} \vert {d}_{i} ) \qquad ( 3 )$$

for query words q₀ . . . qₘ and document (i.e. advertisement) words d₀ . . . dₙ, and where trans(q₁|ⱼ) is a probability of co-occurrence collected over some corpus of parallel queries and documents. The maximum likelihood estimations of the co-occurrence statistics are normalized counts over the training corpus (in this case, the ad click logs):

$$trans ( {q}_{j} \vert {d}_{i} ) = \frac{{\sum }_{logs} count ( {q}_{j} \vert {d}_{i} )}{{\sum }_{q} {\sum }_{logs} count ( q \vert {d}_{i} )} \qquad ( 4 )$$

The translation probability counts the number of clicks a query-ad word pair received, divided by the total number of clicks that the ad word received across all query words. The count function can also be updated with expectation maximization iterations, where the trans(qᵢ|dⱼ) from the previous iteration weights the co-occurrence counts. Additional smoothing operations might be performed over the count values using generalized absolute discounting or other similarity/dissimilarity techniques. The p(D) of EQ. (2) can be represented as a language model, multiplying the probabilities of the document (ad) words that are also collected from the smoothed counts on the click logs.

Two translation models are learned, where the first simply takes the number of clicks as the co-occurrence counts. A second model is then trained using statistics collected over all query-advertisement pair impressions in the logs. Impressions are weighted by “expected clicks” (ec) based on a rank normalization. For an ad a at rank r that has been retrieved for a query q, define ec as:

$$ec ( q , a ) = {\sum }_{r} imp ( q , a , r ) P ( click \vert r ) \qquad ( 5 )$$

where the quantity ec(q,a) is the expected number of clicks summed over all rank positions that an ad appears in, and the quantity P(click|r) is estimated by observing the per-position click-through rate on a sizable portion of search traffic for several days.

Next, take a ratio of the translation probability from the click counts, P_{click}(Q|D), divided by the probability from the expected click counts, p_{ec}(Q|D) to determine a click propensity:

$$clickLikelihood = \frac{{p}_{click} ( Q \vert D )}{{p}_{ec} ( Q \vert D )} \qquad ( 6 )$$

This likelihood ratio, or click propensity, provides a score that removes the presentation bias from the log-based translation models. The p_{click}(Q|D) translation model, based only on clicks, can be biased because a strong click signal may appear from even a low click rate on a massive number of impressions. The above likelihood ratio divides by the probability of clicks that would be expected on average from the weighted impressions, so a query-advertisement pair will have a large ratio when it gets more clicks than would be expected from average term pairs.

### A System for Machine Learning Using Click History as a Relevance Feature

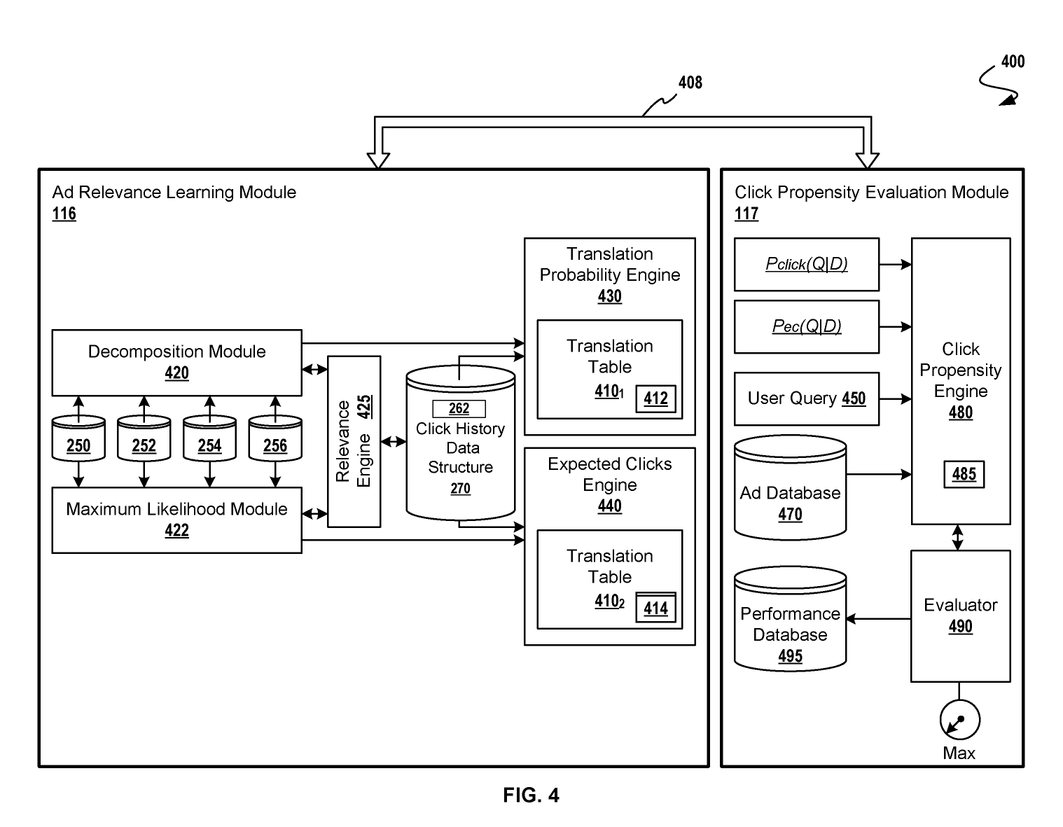

FIG. 4 depicts a system 400 within a search engine server for improving ad relevance in sponsored search. Of course, the system 400 is an exemplary embodiment, and some or all (or none) of the modules or operations or characteristics mentioned in the discussion of FIG. 4 might be carried out or present in any environment. As shown, the system 400 is implemented in the context of environment 100, including an ad relevance learning module 116 and a click propensity evaluation module 117. An ad relevance learning module 116 serves for calculating the aforementioned form of Bayes' rule:

p(D|Q)=p(Q|D)p(D)/p(Q) (2)

The p(Q|D) term can be calculated using a relevance engine 425, thus calculating the decomposition model:

$$p ( Q \vert D ) = {\prod }_{j = 0}^{m} {\sum }_{i = 0}^{n} trans ( {q}_{j} \vert {d}_{i} ) \qquad ( 3 )$$

Also shown in FIG. 4 are a standard translation module 420 and a machine learning module 422 for performing operations to calculate values in the decomposition model. In particular, the machine learned estimations of the co-occurrence statistics are normalized counts over the training corpus (in this case, the ad click logs):

$$trans ( {q}_{j} \vert {d}_{i} ) = \frac{{\sum }_{logs} count ( {q}_{j} \vert {d}_{i} )}{{\sum }_{q} {\sum }_{logs} count ( q \vert {d}_{i} )} \qquad ( 4 )$$

which calculations might be performed by a machine learning module 422.

A translation probability engine 430 learns a translation table 410₁, where the translation table 410₁ stores the co-occurrence counts in a co-occurrence count field 412. Also, an expected clicks engine 440 serves to train a second translation table 410₂, using statistics collected over all query-advertisement pair impressions in the logs where, in particular, impressions are weighted by “expected clicks” (ec) and stored in an expected clicks field 414. That is, for an ad a at rank r that has been retrieved for a query q, define ec as:

$$ec ( q , a ) = {\sum }_{r} imp ( q , a , r ) P ( click \vert r ) \qquad ( 5 )$$

As can be seen the translation probability engine 430 and the expected clicks engine 440 have access to data in the click history data structure 270, and/or raw data from the query set 250, the ad set 252, the rank set 254, and/or the click set 256.

In normal operation (e.g. real-time operation when serving search results) the click propensity evaluation module 117 might receive a user query 450, and select one or more ads from the ad database 470, based on the click propensity score calculated by a click propensity engine 480. More particularly, and as shown, the click propensity engine 480 calculates translation probability, p_{click}(Q|D), Q corresponding to the user query 450, and D corresponding to a candidate ad selected from the ad database 470 divided by the probability from the expected click counts p_{ec}(Q|D) to determine a click propensity:

$$clickLikelihood = \frac{{p}_{click} ( Q \vert D )}{{p}_{ec} ( Q \vert D )} \qquad ( 6 )$$

Of course, the clickLikelihood may be used as a click propensity score 485 for any number of advertisements, and the click propensity score 485 may then be further used for any of a variety of purposes as discussed infra.

It should be noted that any results, including any intermediate/internal or any final/output results, and in particular including any click propensity score 485, may be evaluated against any other goodness measures, possibly including editorial goodness measures resulting from human editorial estimations. The goodness may be determined by an evaluator 490, and goodness or performance metrics may then be stored in a performance database 495 for subsequent use in the adaptation of any of the aforementioned techniques, values, methods, etc. Any goodness or performance metrics stored in a performance database 495 may be communicated to other modules, possibly including the ad relevance learning module 116 over communication path 408.

### Using a Click Propensity Score to Improve the Relevance of a Candidate Set of Ads

As suggested in the discussion of FIG. 3, the scoring of ads as described herein may be used in a variety of applications.

### Filtering Low Relevance Advertisements

One goal of most sponsored search systems is to retrieve a candidate set of relevant ads for a particular search query. In some embodiments, a set of candidate ads is a pool generated by various retrieval technologies that rely on query rewriting methods as well as score-based ad retrieval such as the approaches described herein. Thus, in order to improve the relevance of the final candidate set, some embodiments apply the relevance model (e.g. the click propensity score 485) to each query-advertisement pair in a candidate set, then prune those ads that do not meet a relevance threshold (e.g. a threshold value, or threshold score as compared to click propensity score 485).

Ranking Ads with a Low Click History

Ads with a sparse observed click history may be present in a click history data structure 270. In this section the predicted ad relevance is incorporated as a feature in ranking with the intention of improving click prediction (particularly when only a sparse click history is available). Ads are ranked by a machine-learned model that predicts the probability that the user is likely to click on an ad for a query, p(click|query,ad). A maximum entropy model is learned for this task, which has the following functional form:

$$p ( click \vert query , ad ) = \frac{1}{1 + exp ( {\sum }_{i} {w}_{i} {f}_{i} )} \qquad ( 7 )$$

where fᵢ denotes a feature based on either the query, the ad, or both, and wᵢ is the weight associated with the feature. As earlier described, a query log (e.g. a click history data structure 270) contains a query and an ad, an indication of whether the ad was clicked, and other information such as the time stamp and the position on the page that the ad was shown to a particular user. This data is used to train a binary classifier using the maximum entropy model as described above (see EQ. 7).

In some embodiments, maximum entropy models can also handle sparse and mutually correlated feature sets, and features fᵢ for the model may include various levels of historical click aggregation, as well as other features such as time of day, etc.

### Reducing North Ad Impact

Given a ranked set of candidate ads, the operation of a search engine server 106 implementing sponsored search advertising campaigns should decide how many ads to place in the north (the area above the organic search results). Placing advertisements on top of the organic search results (rather than to the side in the east) creates a direct competition between ads and search results. In some cases, especially for commercial search terms, ads can be more attractive than web results. More frequently, however, they can divert the user's attention and might keep them from ultimately reaching pages containing the information they requested. The search engine can deliberately incur degradation of user experience in exchange for expected revenue. Ads not shown in the north can still be shown in the east or in the south; however, the bulk of both user experience impact and revenue stems from north ads because of their prominent position on the page. One way of measuring search retrieval quality is the Discounted Cumulative Gain (DCG). This is a weighted sum of the editorial relevance (according to human judges) of the top returned documents, where the weight is a decreasing function of the rank:

$${DCG}_{n} = {\sum }_{i = 1}^{n} {w}_{i} \cdot {rel}_{i} \qquad ( 8 )$$

This formula is typically used with graded relevance scores, and weights that place much more importance on higher ranks (use 1/log₂(rank+1)). When ads placed above the search results degrade overall quality, the degradation can be measured as North Ad Impact (NAI), where the percent decrease in DCG introduced by displaying ads is:

$$NAI = \frac{{DCG}_{noAds} - {DCG}_{withAds}}{{DCG}_{noAds}} \qquad ( 9 )$$

The DCG_{noAds} computes DCG over the top five organic search results, while DCG_{withAds} computes DCG over the top five results including ads (for instance, with three north ads, DCG is computed over the three ads and the top two organic search results).

Reduced NAI in the sponsored search system may be attempted by estimating DCG before and after potential north ad placements and choosing to place ads in the north where the lowest NAI penalty (generally when ad relevance is higher and web relevance is lower) is incurred. The ad DCG score is estimated with the relevance model, and the search engine ranking score estimates the organic search DCG score.

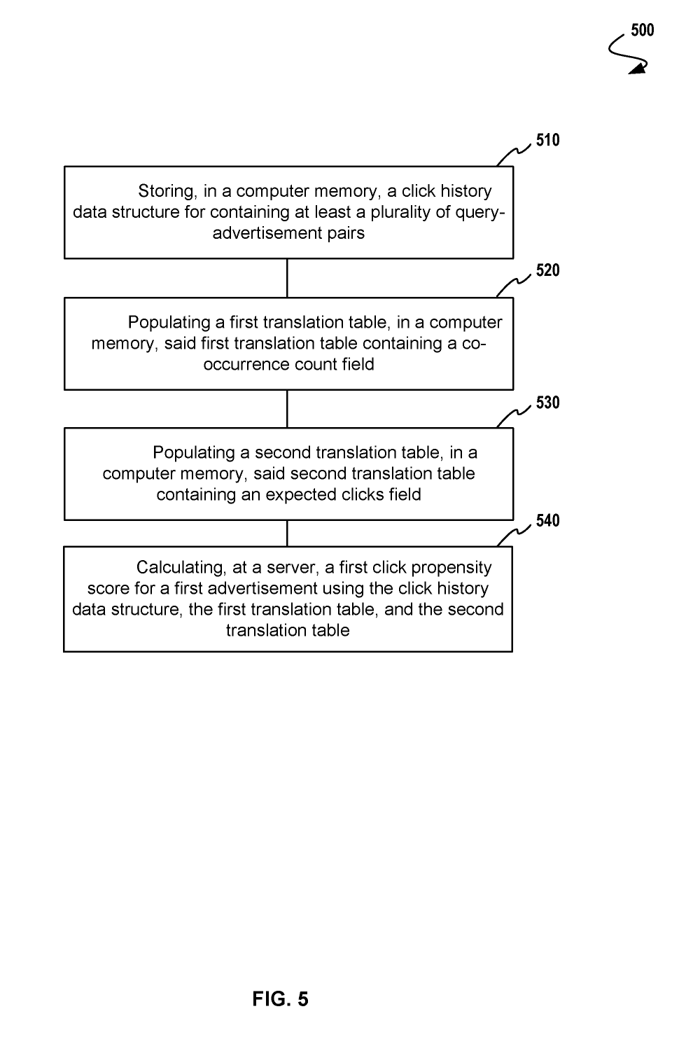

FIG. 5 depicts a method within a system for sponsored search advertising including operations for improving advertisement relevance determination in sponsored search, according to one embodiment. As an option, the present method 500 may be implemented in the context of the architecture and functionality of the embodiments described herein. Of course, however, the method 500 or any operation therein may be carried out in any desired environment. As shown, method 500 includes a plurality of operations, and any operation can communicate with any other operation. Any steps performed within method 500 may be performed in any order unless as may be specified in the claims. As shown, method 500 implements a method for sponsored search advertising, the method 500 comprising operations for: storing, in a computer memory, a click history data structure for containing at least a plurality of query-advertisement pairs (see operation 510); populating a first translation table, in a computer memory, the first translation table containing a co-occurrence count field (see operation 520); populating a second translation table, in a computer memory, the second translation table containing an expected clicks field (see operation 530); and calculating, at a server, a first click propensity score for a first advertisement using the click history data structure, the first translation table, and the second translation table (see operation 540).

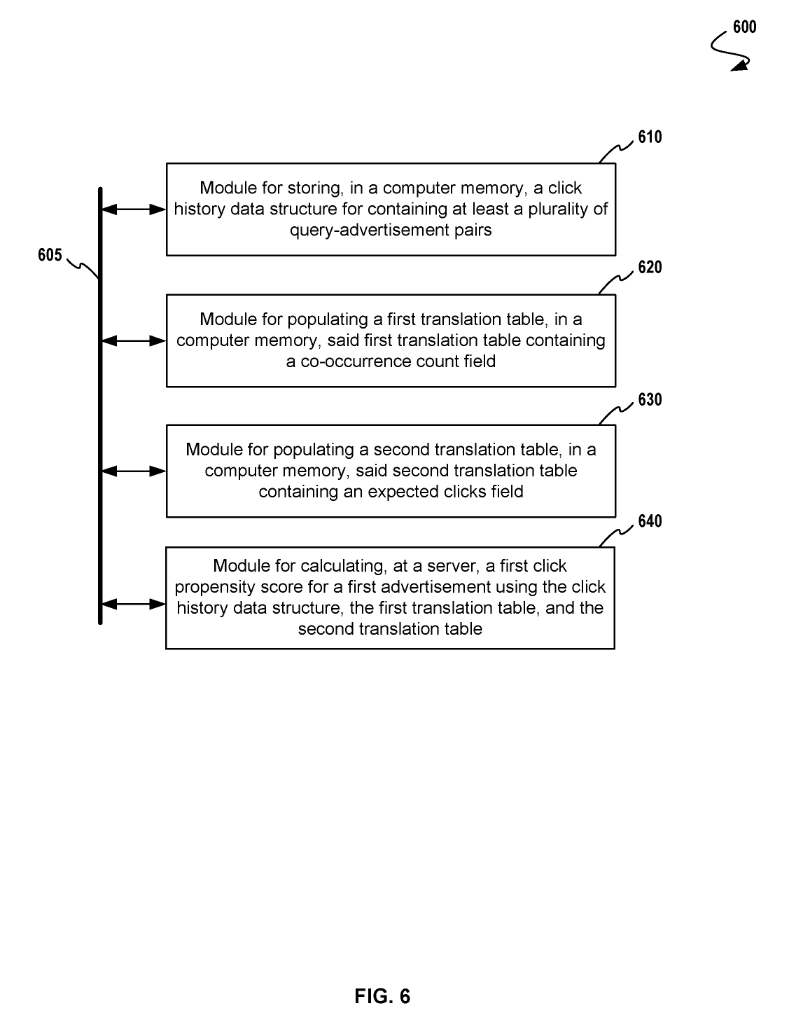

FIG. 6 depicts a block diagram of a system for sponsored search advertising including modules for improving advertisement relevance determination in sponsored search. As an option, the present system 600 may be implemented in the context of the architecture and functionality of the embodiments described herein. Of course, however, the system 600 or any operation therein may be carried out in any desired environment. As shown, system 600 includes a plurality of modules, each connected to a communication link 605, and any module can communicate with other modules over communication link 605. The modules of the system can, individually or in combination, perform method steps within system 600. Any method steps performed within system 600 may be performed in any order unless as may be specified in the claims. As shown, system 600 implements a method for sponsored search advertising, the system 600 comprising modules for: storing, in a computer memory, a click history data structure for containing at least a plurality of query-advertisement pairs (see module 610); populating a first translation table, in a computer memory, the first translation table containing a co-occurrence count field (see module 620); populating a second translation table, in a computer memory, the second translation table containing an expected clicks field (see module 630); and calculating, at a server, a first click propensity score for a first advertisement using the click history data structure, the first translation table, and the second translation table (see module 640).

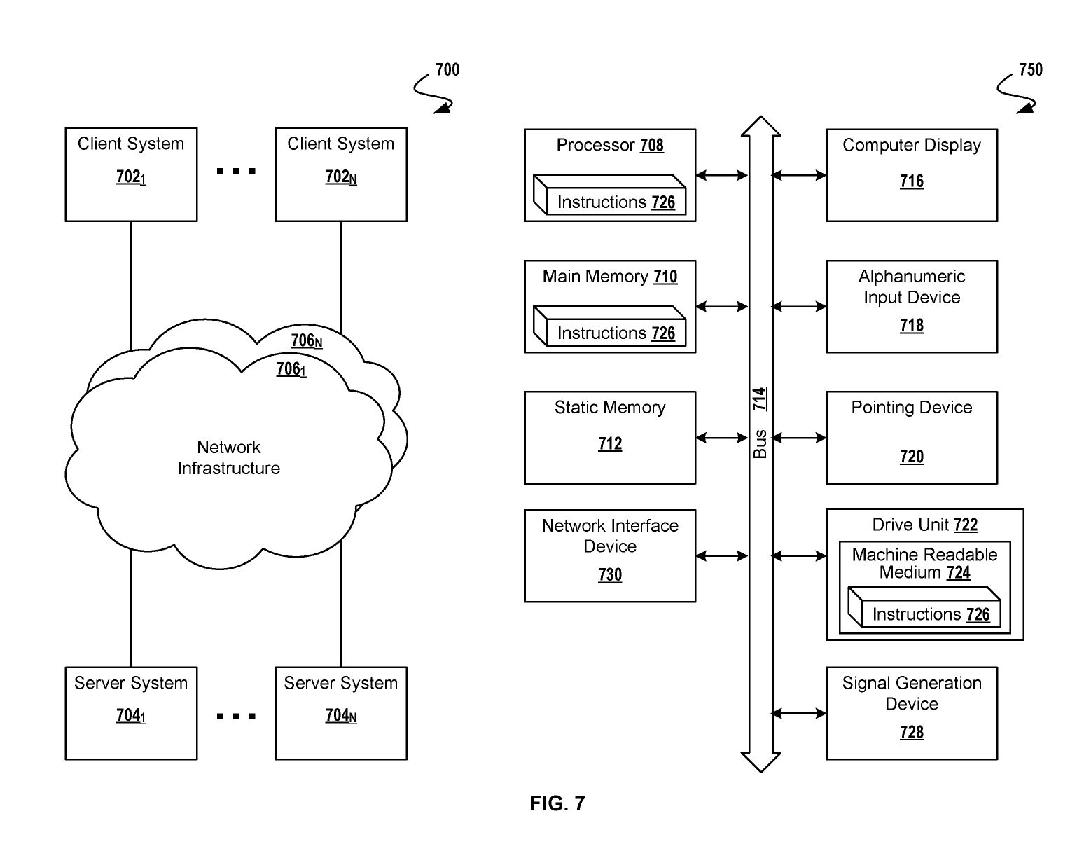

FIG. 7 is a diagrammatic representation of a network 700, including nodes for client computer systems 702₁ through 702_{N}, nodes for server computer systems 704₁ through 704_{N}, and nodes for network infrastructure 706₁ through 706_{N}, any of which nodes may comprise a machine (e.g. computer 750) within which a set of instructions for causing the machine to perform any one of the techniques discussed above may be executed. The embodiment shown is purely exemplary, and might be implemented in the context of one or more of the figures herein.

Any node of the network 700 may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system (e.g. computer 750) includes a processor 708 (e.g. a processor core, a microprocessor, a computing device, etc), a main memory (e.g. computer memory 710), and a static memory 712, which communicate with each other via a bus 714. The computer 750 may further include a display unit (e.g. computer display 716) that may comprise a touch-screen, or a liquid crystal display (LCD), or a light emitting diode (LED) display, or a cathode ray tube (CRT). As shown, the computer system also includes a human input/output (I/O) device 718 (e.g. a keyboard, an alphanumeric keypad, etc), a pointing device 720 (e.g. a mouse, a touch screen, etc), a drive unit 722 (e.g. a disk drive unit, a CD/DVD drive, a tangible computer readable removable media drive, an SSD storage device, etc), a signal generation device 728 (e.g. a speaker, an audio output, etc), and a network interface device 730 (e.g. an Ethernet interface, a wired network interface, a wireless network interface, a propagated signal interface, etc).

The drive unit 722 includes a machine-readable medium 724 on which is stored a set of instructions (i.e. software, firmware, middleware, etc) 726 embodying any one, or all, of the methodologies described above. The set of instructions 726 is also shown to reside, completely or at least partially, within the main memory and/or within the processor 708. The set of instructions 726 may further be transmitted or received via the network interface device 730 over the network bus 714.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for improving advertisement relevance for sponsored search advertising comprising:
storing, in a computer memory, a click history data structure for comprising at least a plurality of query-advertisement pairs;
populating a first translation table, in a computer memory, said first translation table comprising a co-occurrence count field;
populating a second translation table, in a computer memory, said second translation table comprising an expected clicks field; and
calculating, at a server, a first click propensity score for a first advertisement using the first translation table, and the second translation table.

2. The method of claim 1, further comprising:
calculating, at a server, a second click propensity score for a second advertisement using the first translation table, and the second translation table; and
ranking, at a server, at least the first advertisement and the second advertisement based on the first click propensity score and the second click propensity score.

3. The method of claim 1, further comprising: comparing the first click propensity score to a threshold for filtering low quality ad candidates from a plurality of ad candidates.

4. The method of claim 1, further comprising: comparing the first click propensity score the second click propensity score for ordering ads on a sponsored search display page.

5. The method of claim 1, further comprising: comparing the first click propensity score the second click propensity score for optimizing placement of ads on a sponsored search display page.

6. The method of claim 1, wherein the populating the first translation table includes calculating based machine learning estimation of a co-occurrences between a query and an advertisement.

7. The method of claim 1, wherein the populating the second translation table includes calculating based on a ranked position of an advertisement.

8. The method of claim 1, wherein the relevance model contains at least one of a query length, title, an ad description, a display URL.

9. An advertising server network for improving advertisement relevance for sponsored search advertising comprising:
a module for storing, in a computer memory, a click history data structure for comprising at least a plurality of query-advertisement pairs;
a module for populating a first translation table, in a computer memory, said first translation table comprising a co-occurrence count field;
a module for populating a second translation table, in a computer memory, said second translation table comprising an expected clicks field; and
a module for calculating, at a server, a first click propensity score for a first advertisement using the first translation table, and the second translation table.

10. The advertising server network of claim 9, further comprising:
a module for calculating, at a server, a second click propensity score for a second advertisement using the first translation table, and the second translation table; and
a module for ranking, at a server, at least the first advertisement and the second advertisement based on the first click propensity score and the second click propensity score.

11. The advertising server network of claim 9, further comprising: comparing the first click propensity score to a threshold for filtering low quality ad candidates from a plurality of ad candidates.

12. The advertising server network of claim 9, further comprising: comparing the first click propensity score the second click propensity score for ordering ads on a sponsored search display page.

13. The advertising server network of claim 9, further comprising: comparing the first click propensity score the second click propensity score for optimizing placement of ads on a sponsored search display page.

14. The advertising server network of claim 9, wherein the populating the first translation table includes calculating based maximum likelihood estimation of a co-occurrences between a query and an advertisement.

15. The advertising server network of claim 9, wherein the populating the second translation table includes calculating based on a ranked position of an advertisement.

16. The advertising server network of claim 9, wherein the relevance model contains at least one of a query length, title, an ad description, a display URL.

17. A computer readable medium comprising a set of instructions which, when executed by a computer, cause the computer to improve advertisement relevance for sponsored search advertising comprising, the set of instructions for:
storing, in a computer memory, a click history data structure for comprising at least a plurality of query-advertisement pairs;
populating a first translation table, in a computer memory, said first translation table comprising a co-occurrence count field;
populating a second translation table, in a computer memory, said second translation table comprising an expected clicks field; and
calculating, at a server, a first click propensity score for a first advertisement using the first translation table, and the second translation table.

18. The computer readable medium of claim 17, further comprising:
calculating, at a server, a second click propensity score for a second advertisement using the first translation table, and the second translation table; and
ranking, at a server, at least the first advertisement and the second advertisement based on the first click propensity score and the second click propensity score.

19. The computer readable medium of claim 17, further comprising: comparing the first click propensity score to a threshold for filtering low quality ad candidates from a plurality of ad candidates.

20. The computer readable medium of claim 17, further comprising: comparing the first click propensity score the second click propensity score for ordering ads on a sponsored search display page.
